(19) United States
(12) Patent Application Publication
(10) Pub. No.: US 2009/0256368 A1
(43) Pub. Date: Oct. 15, 2009

(54) RECESSED COMPRESSION LATCH

(76) Inventors: Tam Thanh Le, El Monte, CA (US); Everardo Hernandez, Los Angeles, CA (US)

Correspondence Address: CHRISTIE, PARKER & HALE, LLP, PO BOX 7068, PASADENA, CA, 91109-7068, US

(21) Appl. No.: 12/100,230

(22) Filed: Apr. 9, 2008

(51) Int. Cl. E05B 3/00

(52) U.S. Cl. 292/358

(57) ABSTRACT

A recessed compression latch is provided. It has a housing with a recessed well and an aperture, a handle with a pivot end, a shaft pivotally attached to the pivot end of the handle, a shaft housing that fits into and is retained in the aperture in the housing, and a biasing device. The biasing device applies a biasing force that tends to move the shaft out of the shaft housing and biases the handle to an opened position, where the handle extends out of the recessed well, and a closed position, where the handle is folded down into the recessed well. When the handle is in its closed position, the shaft is drawn inwardly towards the housing, and when the handle is in its opened position, the handle will extend out of the recessed well and the shaft will be moved outwardly from the housing, and wherein the handle can only be moved to its closed position when the shaft is in a predetermined rotational alignment relative to the housing.

### BACKGROUND

The invention is a recessed compression latch. Compression latches are used in a variety of applications including for use in securing cabinet and panel doors in a closed position. Compression latches typically include a cam which is attached to a shaft which is moved by a handle.

A shortcoming of existing compression latches is that by virtue of the spacing between moving parts, e.g., a shaft passing through a housing, water may sometimes pass through the compression latch and enter a cabinet. Moreover, the designs of some compression latches remain unnecessarily complex and expensive.

There accordingly remains a need for improved compression latches that are simple in design, easy to assemble, more reliable, low in cost, and resistant to water infiltration.

### SUMMARY OF THE INVENTION

The invention comprises a recessed compression latch that has a housing with a recess, a shaft that rotatably and longitudinally passes through the housing, a cam attached to a lower portion of the shaft below the housing, and a handle attached to the other end of the shaft, which handle is used to both rotate the shaft and cam. The handle and shaft are spring loaded to bias the handle to either a closed position, with the handle folded down into the recess, or an opened position, where the handle is pivoted up and out of the recess. When the handle is folded down into the recess in the housing, which is only possible when the cam is in the locked position, this causes the shaft to be drawn laterally inwardly toward the housing, causing the cam to move from an uncompressed position to a compressed position. It is only in the open position, with the handle pivoted up and out of the recess, that the handle can turn the shaft and its attached cam. Also, the handle can only fold down into a recess in the housing when the compression latch is in the locked position, and will otherwise extend upwardly away from the housing when the latch is unlocked. This feature gives a user a positive indication as to the latched/unlatched state of the compression latch.

To provide for ease of assembly and greater resistance to moisture infiltration through the recessed compression latch, a shaft housing can be provided. The shaft housing has a housing body with a through hole formed therein that is sized to slideably conform to the shaft. An opening is formed in the housing that is sized to receive the shaft housing. The shaft housing has a cavity that is adapted to receive a biasing device, such as a coil spring. One end of the coil spring seats within an end of the cavity of the shaft housing and the other end of the coil spring seats on or engages the shaft. When the shaft is engaged with the coil spring in the shaft housing, this will provide a biasing force. Sealing devices, such as O-rings, can be used to provide a water-tight seal between shaft and the through hole of the shaft housing, and between the shaft housing and the housing.

### BRIEF DESCRIPTION OF THE DRAWINGS

FIG. 1 is a left side isometric view of an exemplary embodiment of a recessed compression latch of the invention, not showing a cam.

FIG. 2 is a top side isometric view of the exemplary embodiment of the recessed compression latch of FIG. 1 in its closed position, showing its cam.

FIG. 3 is an exploded view of the exemplary embodiment of a recessed compression latch of FIG. 1 showing components thereof.

FIG. 4 is a top isometric view of an exemplary embodiment of a housing of the recessed compression latch of FIG. 1.

FIG. 5 is a top view of the exemplary housing of FIG. 4.

FIG. 6 is a cross-section view through view lines 6-6 of FIG. 5.

FIG. 7 is the detail of the housing of the circled area 7 of FIG. 6.

FIG. 8 is a bottom view of the exemplary housing of FIG. 4.

FIG. 9 is a bottom left isometric view of an exemplary embodiment of a handle of the recessed compression latch of FIG. 1.

FIG. 10 is a top right isometric view of the handle of FIG. 9.

FIG. 11 is a bottom view of the handle of FIG. 9.

FIG. 12 is a right side view of the handle of FIG. 9.

FIG. 13 is a front view of the handle of FIG. 9.

FIG. 14 is a bottom view of the handle of FIG. 9.

FIG. 15 is a right side cross-sectional view of the handle of FIG. 9 through view lines 15-15.

FIG. 16 is a left side view of the handle of FIG. 15.

FIG. 17 is an isometric view of an exemplary embodiment of a shaft housing of the recessed compression latch of FIG. 1.

FIG. 18 is a cross-sectional view of the shaft housing through view lines 18-18 of FIG. 17.

FIG. 19 is a top view of an exemplary embodiment of a retaining ring of the recessed compression latch of FIG. 1.

FIG. 20 is an isometric view of an exemplary embodiment of a shaft of the recessed compression latch of FIG. 1.

FIG. 21 is a side view of an exemplary embodiment of a coil spring of the recessed compression latch of FIG. 1.

FIG. 22 is an isometric view of an exemplary embodiment of a lock of the recessed compression latch of FIG. 1.

FIG. 23 is an isometric view of an exemplary embodiment of a lock pin of the recessed compression latch of FIG. 1.

FIG. 24 is a top view of an exemplary embodiment of a gasket of the recessed compression latch of FIG. 1.

FIG. 25 is a top view of an exemplary embodiment of a cam of the recessed compression latch of FIG. 2.

FIG. 26 is a top plan view of the exemplary embodiment of the recessed compression latch of FIG. 1 in the closed position.

FIG. 27 is a cross-section view of the recessed compression latch of FIG. 26 through view lines 27-27.

FIG. 28 is a top plan view of the exemplary embodiment of the recessed compression latch of FIG. 1 in the opened position.

FIG. 29 is a cross-section view of the recessed compression latch of FIG. 28 through view lines 29-29.

FIG. 30 is a bottom view of the recessed compression latch of FIG. 26 in its closed position.

FIG. 31 is a side view of the recessed compression latch of FIG. 26 in its closed position, also showing its handle in the open position in phantom.

### DETAILED DESCRIPTION OF THE INVENTION

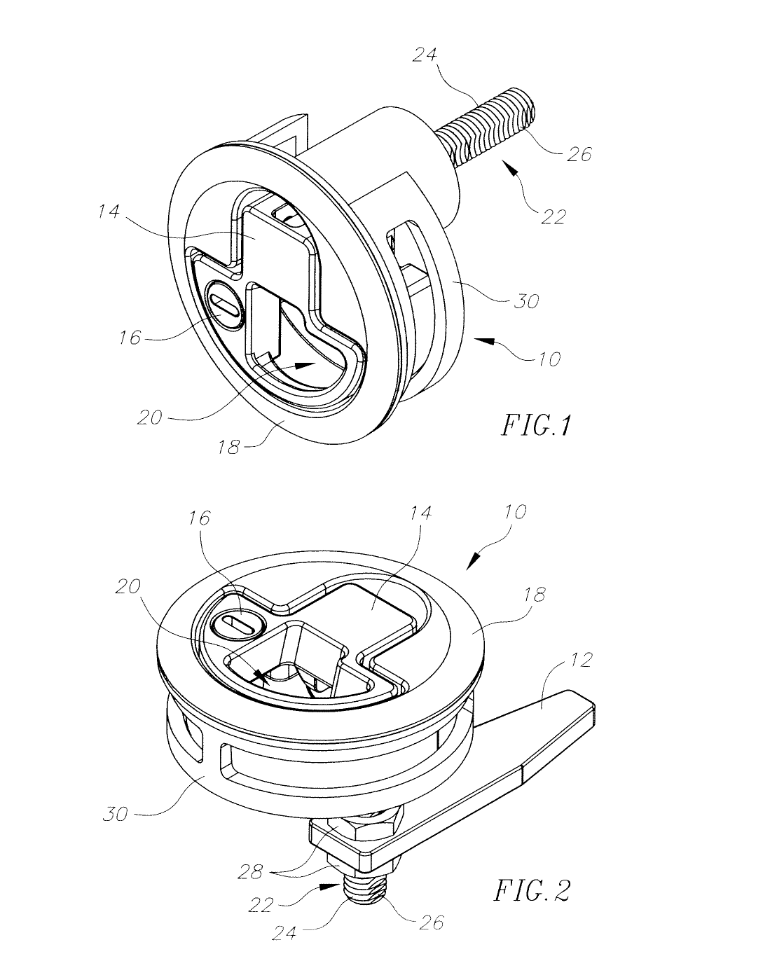

Turning now to the drawings, FIG. 1 is a left side isometric view of an exemplary embodiment of a recessed compression latch 10 of the invention, without showing its cam 12, which is shown in FIG. 2. FIG. 2 is a top isometric view of the exemplary embodiment of the recessed compression latch 10 of FIG. 1 in its locked position showing its cam 12. The recessed compression latch 10 has a handle 14 with lock 16, a housing 18 with a cavity 20 into which the handle is at least partially received, a shaft 22 on which the cam 12 fits. The shaft 22 is shown having a threaded end 24 with flattened sides 26. Retainers, such as threaded nuts 28 can be used to retain the cam 12 on the shaft 20. A mounting cup 30 is also shown, and is used to hold the recessed compression latch 10 in place, as will be described further below. As can partially be seen in FIGS. 1 and 2, the handle 14 fits into a cavity 20 of the housing 18.

FIG. 3 is an exploded view of the exemplary embodiment of a recessed compression latch 10 of FIG. 1 showing the components thereof. Shown are the cam 12, the handle 14, the lock 16, the housing 18 with a cavity 20 (sized to receive the handle 14), the shaft 22 on which the cam 12 fits. The lock 16 rotatably fits in a lock aperture 146 formed in handle 14. The shaft 22 is shown having a threaded end 24 and flattened sides 26. Also shown from before are the threaded nuts 28, used to retain the cam 12 on the shaft 20, and the mounting cup 30. The cam 12 has an aperture 54 formed therein that is sized and shaped so that the cam will not freely rotate on the threaded end 24 of the shaft 22, which is best shown in FIG. 26. For example, the aperture 54 can preferably have flattened sides 56 which will ride on the flattened sides 26 of the threaded end 24 of the shaft 22. Of course, other shapes of the threaded end 24 of the shaft 22 and the complementary aperture 54 can be provided (e.g., hexagonal, square, star-shaped, etc.). The use of nuts 28 permits the longitudinal position of the cam 12 on the shaft 22 to be readily adjusted and locked in the desired position. The lock 16 has a locking device 32, such as a locking pin, that fits with the lock 16. The purpose and function of the locking pin 32 in the lock 16 will be discussed further below. A handle pin 34 is also provided and is sized to fit into an aperture 36 formed in the handle 14. A shaft housing 38 is also provided. The shaft housing 38 has a through hole 40 and has an outer size and dimension that is adapted to fit into a housing aperture 42 formed in the bottom of the recess 20 of the housing 18. A sealing device, such as an O-ring 44, is adapted to fit between the shaft housing 38 and the housing aperture 42 to provide for a good and preferably resistant seal. For that purpose, a channel 46 may be formed at a rim region 48 of the shaft housing 38. The shaft housing 38 has a face 58, which is preferably flat. The cavity 20 has a rough outline 50 that is oversized and is adapted to fit an outline 52 of the handle 14. The through hole 40 is sized to allow the shaft 22 to slideably and rotatably pass therethrough. The shaft 22 has an upper end 60 that is sized to slideably fit through the through hole 40 of the shaft housing 38. The shaft 22 has a spring retainer 62, such as a rim, which spring retainer 62 is adapted to hold a coil spring 64 thereon. Near a top 66 of the shaft, an engagement, such as a pin through hole 68, is formed. The pin through hole 68 is sized to permit the handle 14 to be held to the top of the shaft 22 by the handle pin 34. A shaft sealing device, such as an O-ring 44, is sized to fit around the outer diameter of the upper end of the shaft 60 and provide a seal between the shaft 22 and the through hole 40 of the shaft housing 38. A washer 72 may be placed on the shaft 22 between the O-ring 44 and an upper end 74 of the coil spring 64 to ensure that the O-ring 44 is maintained in close contact with the through hole 40 in order to ensure a watertight seal between the shaft 22 and the shaft housing 38. The shaft 22 has a collar 80, the top of which can be the spring retainer 62. The collar 80 will have a diameter sized larger than the through hole 40. The housing 18 has an internal catch region 82 formed in a lock side wall 84 thereof. The internal catch region 82 can consist of a groove into which the locking pin 32 is adapted to move into when lock 16 is rotated to a locked position when in use (not shown). In situations where no lock is needed, the lock 16 locking pin 32 and the locking region 82 can be eliminated from the device. In such a case, the handle 14 will not have an aperture on its top. The housing 18 has a larger diameter outer rim 86 and a smaller diameter well body 88. In use, the outer rim 86 will seat on a perimeter of an opening formed in a panel (not shown), with the well body 88 passing through the opening (not shown). Also shown is a shaft housing retaining device 90, which can comprise a retaining ring. The retaining ring 90 is used to be retained to a lower end of the shaft holder 38, such as in a retention groove 92 formed thereon. When the shaft holder 38 is placed into the aperture 42 of the housing 18, the retaining ring 90 will prevent the shaft holder 38 from being withdrawn therefrom. A gasket 94 can be included to provide for sealing between the housing 18 (e.g., under the rim 86) and a panel into which the compression latch 10 is mounted. The mounting cup 30 is sized to fit on a back of the housing 18 and can be attached thereto with screws 96 which pass through mounting holes 98 in a back 100 of the mounting cup 30. A front edge 102 of the mounting cup 30 can seat on an inside of the panel to which the compression latch 10 is mounted (not shown). The lock side wall 84 can have a flat top 116 that is located higher than the bottom wall 104 thereof so that when the handle 14 is in the closed position as shown in FIGS. 1 and 2, the handle 14 will impinge on the flat top 116 of the lock side wall 84.

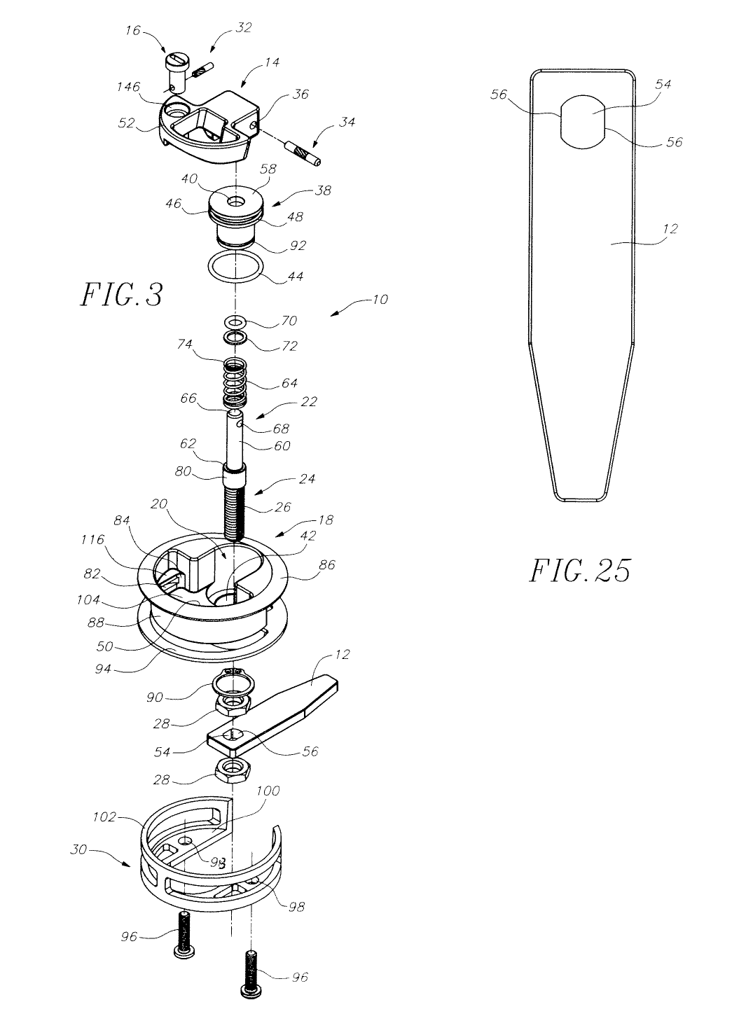

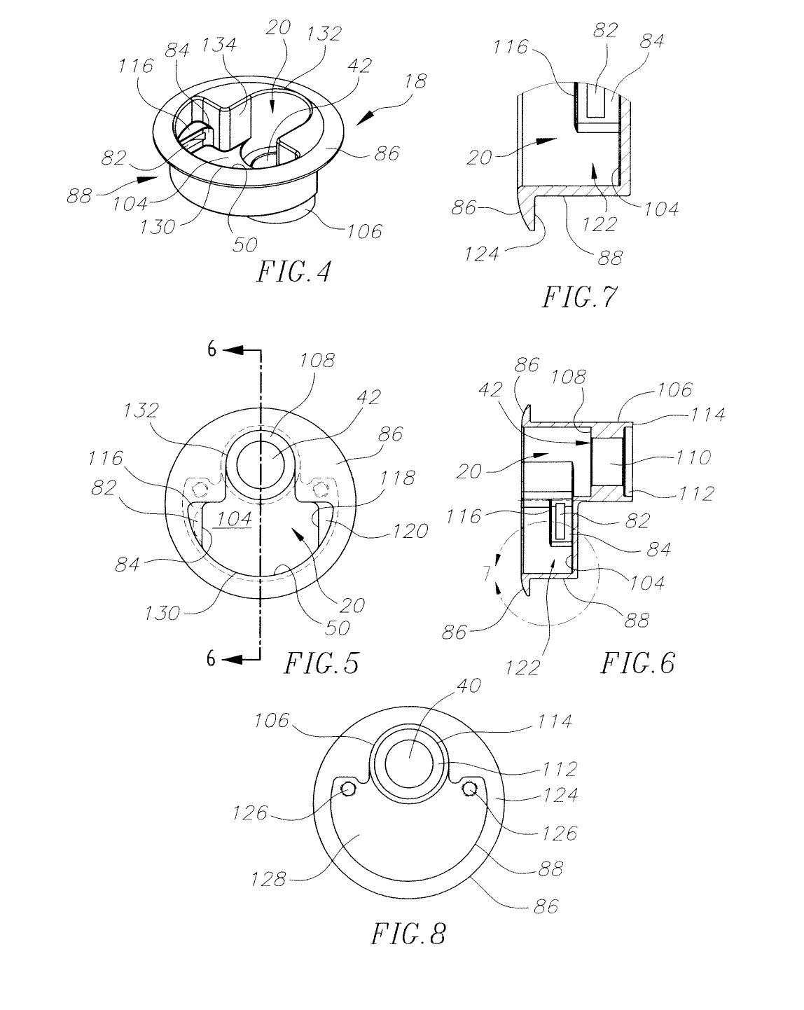

FIG. 4 is a top isometric view of an exemplary embodiment of the housing 18 with the cavity 20 formed therein. The cavity 20 has the aperture 42 formed in a bottom wall 104 thereof. The cavity 20 is sized and shaped so that the handle 14 and other parts fit therein. The internal catch region 82 is in the form of a groove formed in the lock side wall 84 and the flat top 116 is shown. The groove 82 can be formed in a generally horizontal orientation in the lock side wall 84. The larger diameter rim 86 and the smaller diameter well body 88 are shown. Also partially shown is a barrel portion 106 of the cavity 20 through which the aperture 42 passes. As shown, the cavity 20 in the housing 18 can preferably have a rough outline 50 that mimics the shape of the outline 52 of the handle 14. The cavity 20 has a semi-circular portion 130 and a U-shaped portion 132. The aperture 42 passes through the U-shaped portion 132. The U-shaped portion 132 has an inner wall 134.

FIG. 5 is a top view and FIG. 6 is a cross-section view through view lines 6-6 of the housing of FIG. 5. The cavity 20, aperture 42, and bottom wall 104 are shown. As noted above, the cavity 20 is sized and shaped in an outline so that the handle 14 and other parts fit therein. The internal catch region 82 in the form of a groove is shown formed in the lock side wall 84 which has a flat top 116. The groove 82 can be formed in a generally horizontal orientation in the lock side wall 84. The larger diameter rim 86 and the smaller diameter well body 88 are shown. Also shown is the barrel portion 106 of the cavity 20 through which the aperture 42 passes. A seat 108 is formed in the barrel portion 106, and the aperture 42 is wider above the seat 108 and is narrower below the seat 108 in a throat region 110. A rim 112 is formed at a terminating end 114 of the barrel portion 106. The flat top 116 of the lock side wall 84 is shown located higher than the bottom wall 104 so that when the handle 14 is in the closed position as shown in FIGS. 1 and 2, the handle 14 will impinge on the flat top 116 of the lock side wall 84. Opposite the lock side wall 84 there can be another raised wall 118, which also preferably has a flat top 120 which is also located such that the handle 14 will impinge thereon when in the closed position. Thus, there will be a below handle space 122 below the tops 116 and 120 of the lock side wall 84 and the raised wall 118, which will be available for a person's finger to help grasp the handle 14 when opening the handle (not shown).

FIG. 7 is the detail of the circled area 7 of the housing of FIG. 6. Shown are cavity 20, rim 86, well body 88, portions of the internal catch region 82, lock side wall 84, flat top 116, bottom wall 104 and below handle space 122. The rim 86 has an underside 124 which will seat on a perimeter of an aperture through which the compression latch 10 will be mounted (not shown).

FIG. 8 is a bottom view of the exemplary housing 18 of FIG. 4. The through hole 40, rim 86, well body 88, underside of rim 124, barrel portion 106, rim 112, and terminating end 114 are shown. Also shown are threaded mounting holes 126 formed on a bottom of housing 128. The threaded mounting holes 126 are adapted to receive the screws 96 which hold the mounting cup 30 on the housing 18. (See FIGS. 1-3)

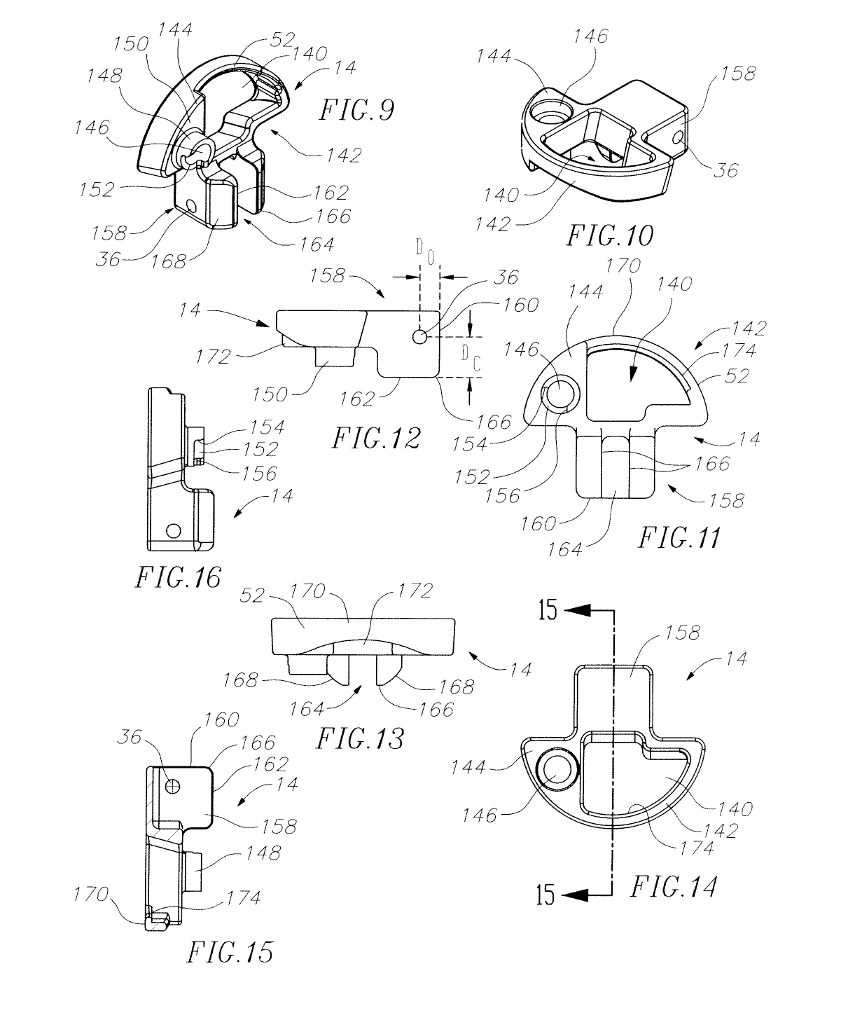

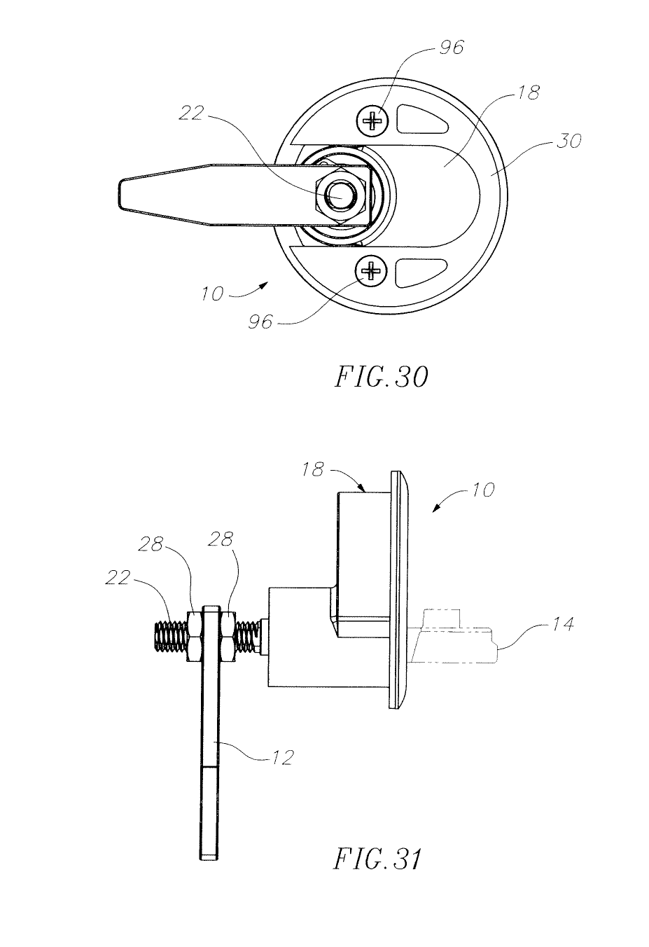

FIGS. 9-16 are various views of the exemplary handle 14 of the compression latch 10 of FIG. 1, with FIG. 9 being a bottom left isometric view, FIG. 10 being a top right isometric view, FIG. 11 being a bottom view, FIG. 12 being a right side view, FIG. 13 being a front view, FIG. 14 being a bottom view, FIG. 15 being a right side cross-sectional view, and FIG. 16 being a left side view of the handle though view lines 15-15 of FIG. 15. Handle 14 has a grip opening 140 formed in an arcuate grip portion 142, the outer rim of which partially forms the outline 52 of the handle 14. Adjacent to the grip opening 140 is a platform 144. The lock aperture 146 is formed through the platform 144. The lock aperture 146, preferably generally cylindrical, projects through a barrel portion 148 extending from a lower surface 150 of the platform. The barrel portion 148 has a cutout 152 which provides about a 90° section of a bottom portion of the barrel portion removed. The cutout 152 has a lock stop 154 and an unlock stop 156. The lock aperture 146 will preferably be wider at an upper portion and be narrower in the barrel portion 148. As will be described further below with reference to FIG. 28, the lock 16 will be inserted into the lock aperture 146 and the locking pin 32 will be inserted into an aperture 216 of the lock. (See FIG. 22) The locking pin 32 will not only prevent the lock 16 from being withdrawn from the lock aperture 146, but in the cutout portion 152 will limit the range of rotation motion from the locked position, where the locking pin 32 will be positioned in the groove of the internal catch region 82 and moved against the lock stop 154, thereby locking the handle 14 in the cavity 20 of the housing 18, to an unlocked position where the locking pin 32 is not captured and rests against the unlock stop 156 in which position the handle 14 can be moved to the opened position, as best shown in FIG. 30. Turning back to the figures that describe the handle 14, the handle has a pivot end 158 through which the aperture 36 passes. The pivot end 158 has a flattened end 160 and two flat sides 162 that straddle a slot 164. The slot 164 is sized so that when the handle is attached with pin 34 to shaft 22, the handle 14 can be pivoted relative to the shaft 22. The pivot end 158 has a rounded interface 166 where the flattened end 160 merges to the flat sides 162. This rounded interface 166 will provide for smoother operation as the handle is moved between the closed/locked position, as best shown in FIG. 28, to the unlocked position, as best shown in FIG. 30. The U-shaped portion 132 of the cavity 20 of the housing 18 is where the pivot end 158 operates and is located. The slot 164 is oriented towards the grip opening 140. From the flat sides 162 straddling the slot 164 and extending to the sides thereof, curved walls 168 are provided. These curved walls 168 are useful in that if the handle 14 is not perfectly aligned to be brought to a closed position into the cavity 20 of the housing 14, e.g., if the handle is rotated slightly, when the handle is folded down, the curved walls 168 will impinge on the inner walls 134 of the U-shaped portion 132, which will automatically tend to align the handle 14. Indeed, by virtue of the alignment of the slot 164, this function can be quite smooth. At a front portion 170 of the arcuate grip portion 142, there is provided a relief 172 to provide more space for a finger to grasp the handle. A rim 174 can also be provided to aid the user in gripping the front portion 170 of the arcuate grip portion 142 and moving it. Referring to FIG. 12, the distance Dₒ between the flattened end 160 and the aperture 36 is shorter than the distance D_{c} between the flat sides 162 and the aperture 36. Thus, as will be apparent with reference to FIGS. 28 and 30, the shaft 22 will be pulled inwardly towards the housing 18 when the handle 14 is flipped down into the housing 18, and the shaft 22 will be allowed to extend further outwardly when the handle 14 is flipped up outside the housing 18. In the locked/closed position of FIG. 28, the flat sides 162 will seat on the face 58 of the shaft housing 38 and be retained there by being biased by the coil spring 64. In the unlocked/opened position of FIG. 30, the flattened end 160 will seat on the face 58 of the shaft housing 38 and will also be retained there by being biased by the coil spring 64. In the movement between the locked/closed position of FIG. 28 and the unlocked/opened position of FIG. 30, the rounded interface 166 will move to a position where it is in line with the aperture 36, at which position the handle will be in balance. By moving the handle 14 downwardly into the housing 18, the rounded interface 166 will move out of line with the aperture and away from the semi-circular portion 130 of the cavity 20 and the coil spring 64 will retain it biased in the position shown in FIG. 30. By moving the handle 14 upwardly out of housing 18, the rounded interface 166 will be out of line with the aperture and towards the semi-circular portion 130 of the cavity 20 and the coil spring 64 will retain it biased in the position shown in FIG. 28.

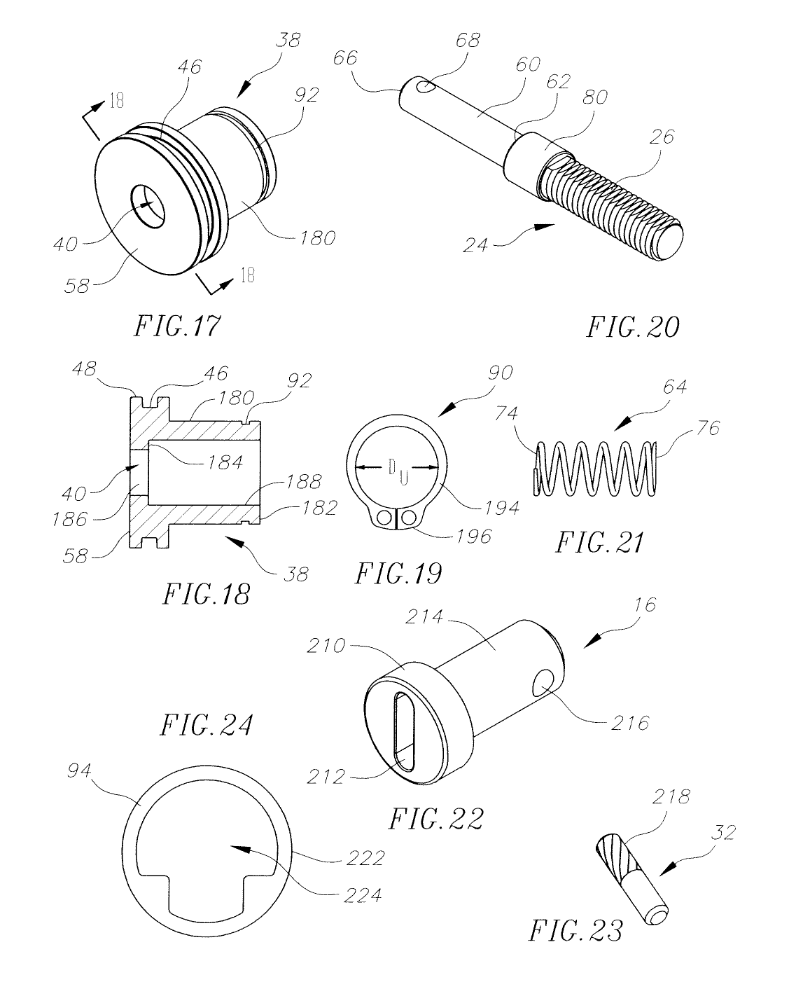

FIG. 17 is an isometric view of an exemplary embodiment of the shaft housing 38 of the recessed compression latch of FIG. 1 and FIG. 18 is a cross-sectional view of the shaft housing 38 of FIG. 17 through view lines 18-18. As noted above with reference to FIG. 3, the shaft housing 38 has a through hole 40 and has an outer size and dimension that is adapted to fit into a housing aperture 42 formed in the bottom of the recess 20 of the housing 18. The device, such as an O-ring 44 (shown in FIG. 3) is adapted to fit between the shaft housing 38 and the housing 18 to provide for a good and preferably resistant seal. For that purpose, the channel 46 may be formed at the rim region 48 of the shaft housing 38. The shaft housing 38 has a face 58, which is preferably flat. Behind the face 58, the shaft housing 38 narrows into a cylindrical portion 180 with a terminating end 182, with the retention groove 92 formed near the end. The through hole 40 has a narrower region 186 in the face 58 and a wider region 188 in the cylindrical portion 180. A seat 184 is formed in the interface between the narrower region 186 and the wider region 188. This is to accommodate the coil spring 64 shown in FIGS. 3 and 21, which is sized to fit around the upper end 60 of the shaft 22, and be retained with upper end 74 of the coil spring 64 placed against the seat 184 and the lower end 76 of the coil spring 64 contacting the spring retainer 62 of the shaft 22. The narrower region 186 is sized to slideably fit the upper end 60 of the shaft 22. The wider region 188 is sized to slideably fit the collar 80 of the shaft 22, and the O-ring 70 (see FIG. 3) will be held in place against the upper end 60 of the shaft 22 in the seat area 184 by spring tension created by the spring 64, as is shown in FIGS. 28 and 30. The shaft housing 38 has a length such that when the shaft housing 38 is placed into the aperture 42 of the U-shaped portion 132 of the cavity 20, the retention groove 92 will be aligned with the rim 112. As shown in FIGS. 3, 28 and 30, the retaining device 90 (as best shown in FIG. 19) will snap in the retention groove 92 and thus retain the shaft housing 38 in place in the aperture 42 of the housing 18. The retaining device 90 will have a rim section 194 with an unexpanded inner diameter Dᵤ and two separatable ends 196 which can be used to expand the inner diameter Dᵤ when locking the retaining device 90 onto the retention groove 92 when in place in the aperture 42 of the housing 18.

FIG. 20 is an isometric view of an exemplary embodiment of the shaft 22. The shaft's threaded end 24 with flattened sides 26, its upper end 60, its collar 80 and spring retainer (a rim) 62, the top 66 and the pin through hole 68 are shown. The profile of the shaft's threaded end 24 will be adapted to slideably fit through the aperture 54 in the cam 12, as shown in FIGS. 28 and 30.

FIG. 21 is a side view of an exemplary embodiment of the coil spring 64 with its upper end 74 and lower end 76. The coil spring 64 will have an inner diameter sized to slide over the upper end 60 of the shaft 22. The coil spring 64 will have an uncompressed length sufficient so even in the open position of the compression latch of FIG. 30, the coil spring 64 will remain under some compression so that the handle 14 will require some force to move it to the closed position of FIG. 30. The spring constant k can be selected based on design considerations, and the shaft 22 can be of conventional design with its upper and lower ends 74 and 76 being equivalent. An optional washer 72 is shown in FIG. 3 located between the upper end 74 of the coil spring 64 and the O-ring 70.

FIG. 22 is an isometric view of an exemplary embodiment of the lock 16 of the recessed compression latch of FIG. 1. The lock 16 has a head 210 with a turning device, such as slot 212. Below the head is a barrel 214 with an aperture 216 formed therein. The locking pin 32, as shown in FIG. 23, can have a contoured end 218 which is compression fit into the aperture 216. When the lock 16 is inserted into the lock aperture 146 of the handle 14 (see FIGS. 3, 9 and 10), the locking pin 32 will prevent the lock 16 from being withdrawn from the lock aperture 146. The locking pin 32 will sit against the cutout 152, which has a lock stop 154 and an unlock stop 156, which limit the rotational movement of the lock 16 and its locking pin 32 by about 90 degrees of rotation. When the lock 12 is rotated such that the locking pin 32 impinges on the lock stop 154, the locking pin 32 will be aligned so that it is moved into the internal catch region 82, which prevents the handle 14 from being lifted up and opened. When the lock is rotated such that the locking pin 32 impinges on the unlock stop 156, the locking pin 32 will be aligned so that it is moved out of the internal catch region 82, which allows the handle 14 to be lifted up and opened.

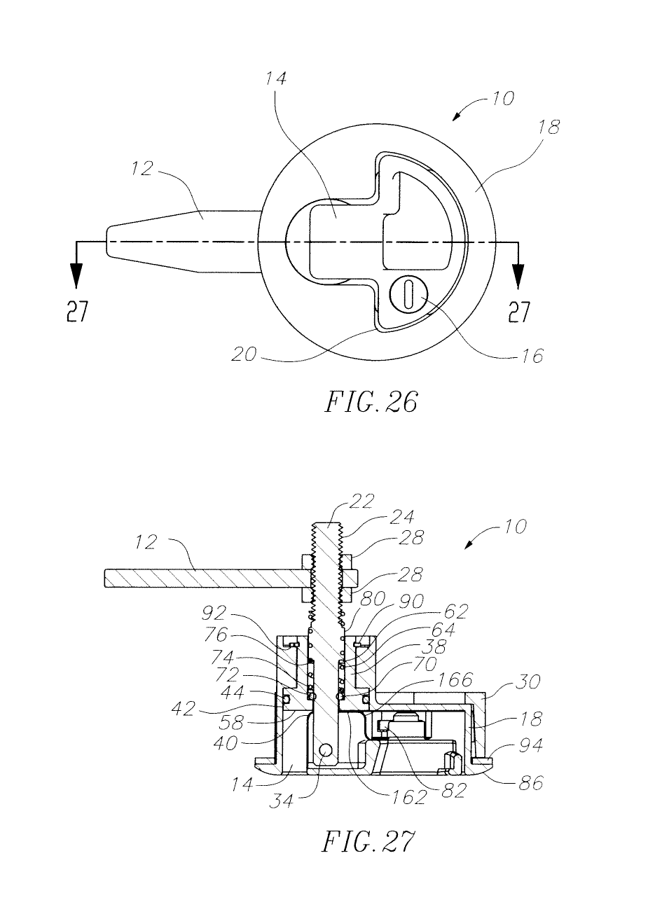

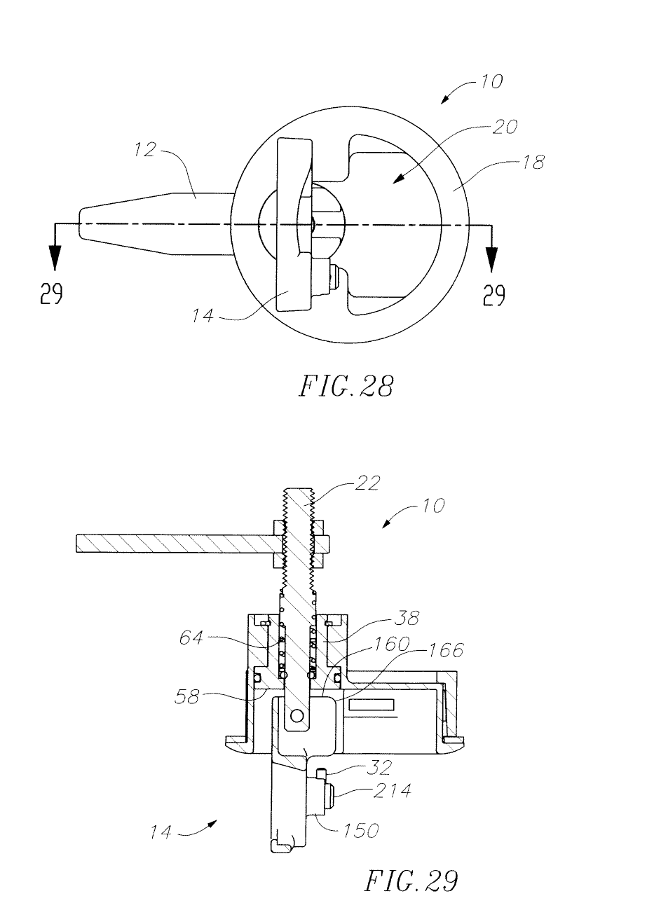

FIG. 24 is a top view of an exemplary embodiment of the gasket 94 of the recessed compression latch of FIG. 1. It has an outer rim 222 and an aperture 224 sized to be received around the outside of the well body 88 and seat under the rim 86 of the housing 18.

FIG. 25 is a top view of an exemplary embodiment of a cam 12 of the recessed compression latch of FIG. 2. It has an aperture 54 and can have flattened sides 56 to engage with the flattened sides 26 of the shaft 22 (see FIG. 3). The cam 12 can have other aperture shapes as necessary to prevent rotation of the cam 12 relative to the shaft 22.

FIG. 26 is a top plan view of the exemplary embodiment of the recessed compression latch 10 of FIG. 1 in the closed position. As can be seen, the handle 14 is positioned in its closed position in the cavity 20 of the housing 18. The lock 16 in the handle 14 is shown, as is the cam 12.

FIG. 27 is a cross-sectional view of the assembled recessed compression latch 10 of FIG. 26 through view lines 27-27, in the closed position, and shows the various parts in an assembled condition. The cam 12 is shown attached by nuts 28 to threaded end 24 of shaft 22. The shaft 22 is inserted through the aperture 40 of shaft housing 38 with the lower end 76 of coil spring 64 seated on spring retainer 62 of its collar 80. The upper end 74 of the coil spring 64 seats on washer 72, which impinges on O-ring 70 to ensure a good seal between the aperture 40 in the shaft housing 38 and the shaft 22. The coil spring 64 will bias the shaft 22 and its associated cam 12 outward out of the bottom of the housing 18. The O-ring 40 for the shaft housing 38 provides a watertight seal between the shaft housing 38 and the aperture 42 of the housing 18. The retaining ring 90 is retained in the retention groove 92 of the shaft housing 38 to keep it in place in the housing 18. The flat sides 162 of the handle 14 ride on face 58 of the shaft housing 38, and the coil spring 64 biases the handle 14 to remain in this orientation. The handle 14 is attached to the shaft 22 by the handle pin 34. The internal catch region 82 is shown, as is the gasket 94 and mounting cup 20.

FIG. 28 is a top plan view of the exemplary embodiment of the recessed compression latch of FIG. 1 in the open position. As can be seen, the handle 14 is rotated up in an opened position extending out of the mounting cup 20 of the housing 18.

FIG. 29 is a cross-section view of the recessed compression latch of FIG. 28 through view lines 29-29 in the opened position. As can be seen, the handle 14 is rotated up to its opened position to extend out of the cavity 20 of the housing 18. In this position, the flattened end 160 of the handle 144 rides on the face 58 of the shaft housing 38. Since the distance Dₒ between the handle pin 34 and the flattened end 160 is shorter than the distance between the handle pin 34 and the flat side 162 of the handle 14 (as shown in FIG. 27), the shaft 22 and its associated cam 12 will extend outwardly from the housing 18 to a greater extent than in the locked embodiment of FIG. 27. However, since the coil spring 64 continues to bias the shaft 22, the handle will remain in the opened position. Referring back to FIG. 12, the distance Dₒ between the flattened end 160 and the aperture 36 is shorter than the distance D_{c} between the flat sides 162 and the aperture 36. Thus, as the shaft 22 will be pulled inwardly towards the housing 18 when the handle 14 is flipped down into the housing 18, and the shaft 22 will be allowed to extend further outwardly when the handle 14 is flipped up outside the housing 18. In the locked/closed position of FIG. 28, the flat sides 162 will seat on the face 58 of the shaft housing 38 and be retained there by being biased by the coil spring 64. In the unlocked/opened position of FIG. 30, the flattened end 160 will seat on the face 58 of the shaft housing 38 and will also be retained there by being biased by the coil spring 64. In the movement between the locked/closed position of FIG. 28 and the unlocked/opened position of FIG. 30, the rounded interface 166 will move to a position where it is in line with the aperture 36, at which position it is in balance. By moving the handle 14 downwardly into the housing 18, the rounded interface 166 will move out of line with the aperture and away from the semi-circular portion 130 of the cavity 20 and the spring 64 will retain it biased in the position shown in FIG. 30. By moving the handle 14 upwardly out of housing 18, the rounded interface 166 will be out of line with the aperture and towards the semi-circular portion 130 of the cavity 20 and the coil spring 64 will retain it biased in the position shown in FIG. 28.

FIG. 30 is a bottom view of the recessed compression latch 10 of FIG. 26 in its locked position. The mounting cup 30 is shown attached to the back of housing 18 by screws 96, and the cam 12 is shown attached to the shaft 22.

FIG. 31 is a side view of the recessed compression latch 10 of FIG. 26 in its locked position, also showing its handle 14 in the open position in phantom extending out of the housing 18.

Although embodiments of the present invention have been described in detail hereinabove in connection with certain exemplary embodiments, it should be understood that the invention is not limited to the disclosed exemplary embodiments, but, on the contrary is intended to cover various modifications and/or equivalent arrangements included within the spirit and scope of the present invention.

What is claimed is:

1. A recessed compression latch, comprising:
a housing with a recessed well;
a handle with a pivot end;
a shaft pivotally attached to the pivot end of the handle; and
a biasing device;
wherein the biasing device applies a biasing force that tends to move the shaft out of the housing and will bias the handle to an opened position, where the handle extends out of the recessed well, and a closed position where the handle is folded down into the recessed well, and wherein when the handle is in its closed position, the shaft is drawn inwardly towards the housing, and when the handle is in its opened position, the handle will extend out of the recessed well and the shaft will be moved outwardly from the housing, and wherein the handle can only be moved to its closed position when the shaft is in a predetermined rotational alignment relative to the housing.

2. The recessed compression latch of claim 1, further comprising a shaft housing that fits into and is retained in an aperture in the housing, the shaft housing having a through hole that is sized to slideably receive the shaft, wherein the biasing device comprises a coil spring placed on the shaft in the vicinity of the shaft housing.

3. The recessed compression latch of claim 2, wherein sealing devices provide for a water tight seal between the shaft and the shaft housing, and between the shaft housing and the housing.

4. The recessed compression latch of claim 1, wherein the pivot end of the handle is sized to fit in a handle pivot end portion of the recessed well in the housing, the pivot end of the handle having a flattened lower end which seats on a lower wall of the recessed well, a slot into which an upper end of the shaft is pivotally attached to the handle, and side walls that permit the pivot end of the handle to be rotated in the handle pivot end portion of the recessed well, the handle pivot end portion of the recessed well opening into a handle grip portion of the recessed well.

5. The recessed compression latch of claim 2, wherein the pivot end of the handle is sized to fit in a handle pivot end portion of the recessed well in the housing, the pivot end of the handle having a flattened lower end which seats on an upper face of the shaft housing, a slot into which an upper end of the shaft is pivotally attached to the handle, and side walls that permit the pivot end of the handle to be rotated in the handle pivot end portion of the recessed well, and wherein the handle pivot end portion of the recessed well opens into a handle grip portion of the recessed well.

6. The recessed compression latch of claim 1, further comprising a cam that is attached to the shaft.

7. The recessed compression latch of claim 6, wherein the shaft is threaded at a lower end thereof and has an out of round cross section onto which the cam is non-rotatably affixed by threaded nuts and wherein a longitudinal position of the cam on the shaft is adjustable by the threaded nuts.

8. The recessed compression latch of claim 1, wherein the handle has a grip portion that fits in a handle grip portion of the recessed well.

9. The recessed compression latch of claim 1, wherein the grip portion has an aperture formed therein and a perimeter for gripping.

10. The recessed compression latch of claim 1, further comprising a lock for locking the handle in the closed position.

11. The recessed compression latch of claim 10, wherein the lock is positioned in the handle and has a locking pin that moves into contact with a portion of the well to lock the handle and moves out of contact with a portion of the well to unlock the handle.

12. The recessed compression latch of claim 1, wherein the shaft is threaded at a lower end thereof, onto which the cam is positioned.

13. A recessed compression latch, comprising:
a housing with a recessed well and an aperture;
a handle with a pivot end;
a shaft pivotally attached to the pivot end of the handle;
a shaft housing that fits into and is retained in the aperture in the housing; and
a biasing device, the biasing device applying a biasing force that tends to move the shaft out of the shaft housing and biases the handle to an opened position, where the handle extends out of the recessed well, and a closed position, where the handle is folded down into the recessed well, and wherein when the handle is in its closed position, the shaft is drawn inwardly towards the housing, and when the handle is in its opened position, the handle will extend out of the recessed well and the shaft will be moved outwardly from the housing, and wherein the handle can only be moved to its closed position when the shaft is in a predetermined rotational alignment relative to the housing.

14. The recessed compression latch of claim 13, wherein the shaft housing has a through hole that is sized to slideably receive the shaft and wherein the biasing device comprises a coil spring placed on the shaft in the vicinity of the shaft housing.

15. The recessed compression latch of claim 13, wherein sealing devices provide for a water tight seal between the shaft and the shaft housing, and between the shaft housing and the housing.

16. The recessed compression latch of claim 13, wherein the pivot end of the handle is sized to fit in a handle pivot end portion of the recessed well in the housing, the pivot end of the handle having a flattened lower end which seats on a lower wall of the recessed well, a slot into which an upper end of the shaft is pivotally attached to the handle, and side walls that permit the pivot end of the handle to be rotated in the handle pivot end portion of the recessed well, the handle pivot end portion of the recessed well opening into a handle grip portion of the recessed well.

17. The recessed compression latch of claim 16, wherein the pivot end of the handle is sized to fit in a handle pivot end portion of the recessed well in the housing, the pivot end of the handle having a flattened lower end which seats on an upper face of the shaft housing, a slot into which an upper end of the shaft is pivotally attached to the handle, and side walls that permit the pivot end of the handle to be rotated in the handle pivot end portion of the recessed well, and wherein the handle pivot end portion of the recessed well opens into a handle grip portion of the recessed well.

18. The recessed compression latch of claim 13, further comprising a cam that is attached to the shaft.

19. The recessed compression latch of claim 18, wherein the shaft is threaded at a lower end thereof and has an out of round cross section onto which the cam is non-rotatably fixed by threaded nuts and wherein a longitudinal position of the cam on the shaft is adjustable by the threaded nuts.

20. The recessed compression latch of claim 13, wherein the handle has a grip portion that fits in a handle grip portion of the recessed well, the grip portion having an aperture formed therein and a perimeter for gripping.

21. The recessed compression latch of claim 13, further comprising a lock for locking the handle in the closed position.

22. The recessed compression latch of claim 21, wherein the lock is positioned in the handle and has a locking pin that moves into contact with a portion of the well to lock the handle and moves out of contact with a portion of the well to unlock the handle.
